(19) United States
(12) Patent Application Publication
(10) Pub. No.: US 2007/0082679 A1
(43) Pub. Date: Apr. 12, 2007

(54) Telematics transport gateway and operating method thereof

(76) Inventors: Chul-Su Kim, Daejon (KR); Jong-Ik Kim, Daejon (KR); Woo-Yong Han, Daejon (KR); Oh-Cheon Kwon, Daejon (KR); Jin-Ho Song, Seoul (KR)

Correspondence Address: LADAS & PARRY LLP, 224 SOUTH MICHIGAN AVENUE, SUITE 1600, CHICAGO, IL, 60604, US

(21) Appl. No.: 11/528,906

(22) Filed: Sep. 28, 2006

(30) Foreign Application Priority Data
Sep. 29, 2005 (KR) 10-2005-0091608
Jun. 29, 2006 (KR) 10-2006-0059464

(51) Int. Cl. G05D 1/00; G01C 21/00; H04Q 7/20

(52) U.S. Cl. 455/456.1; 370/352; 701/1; 701/200

(57) ABSTRACT

Provided are a telematics transport gateway and an operating method thereof. The telematics transport gateway, includes: a message transporting/receiving unit for receiving service request messages, transmitting the service request messages to a service providing server, receiving a service response message and transporting the service response message to the telematics terminal; a message processing unit for analyzing whether a format of the service request messages is Short Message Service (SMS), Transmission Control Protocol (TCP), or Hypertext Transfer Protocol (HTTP); a controlling unit for extracting user information from the service request message, transmitting the user information to an authentication managing unit and a charging unit, and maintaining a session with the telematics terminal; the authentication managing unit for performing authentication and transporting an authentication result to the controlling unit; and the charging unit for charging for the service.

### FIELD OF THE INVENTION

The present invention relates to a telematics transport gateway and an operating method thereof; and, more particularly, to a telematics transport gateway for relaying information exchange between a telematics terminal in a vehicle and a telematics service providing system, and an operating method thereof.

### DESCRIPTION OF RELATED ART

A telematics is a compound word of telecommunication and informatics. According to a telematics system, a vehicle is connected to a center for providing a service through a wireless communication. The vehicle inputs a destination and requests a route guiding service to the center. The center sets up an optimum route for the destination and provides a route guiding service.

In addition, when a mobile communication terminal is used, the telematics has a mobile communication hands-free function for providing a call service with a second party, to which a communication line is connected, in a hands free state, a function for searching diverse life information and contents, and providing the searched information in real-time, a function for recovering audio/video signals stored in diverse media such as a cassette tape, CD, DVD, and MP3 and a function for outputting terrestrial broadcasting reception such as a radio and television (TV).

The telematics provides a screen according to a touch screen inputting method. When a destination is designated by using diverse function buttons provided on the screen in a state activated into a destination input mode, the center connected through a wireless communication network searches a route to the destination and outputs the route on the screen of the telematics.

Also, the center searches information on diverse events including traffic jam, accidents, construction sites and demonstration schedule that happens on the route during operation, and provides the information to the telematics in real-time. Accordingly, a driver can actively cope with the diverse events.

In general, a telematics terminal for a vehicle loaded with an application program which can process a telematics service is required to receive the telematics service from the telematics service providing system. The application program is developed as a communication module which is proper to a communication method of the telematics service providing system and loaded in the telematics terminal.

The telematics service providing system should have a communication module which fits to an operation system or characteristics including a communication method of each telematics terminal to provide the telematics service to the telematics terminal having a different communication method. Accordingly, a cost for maintaining the telematics service providing system increases.

Meanwhile, KR Patent Application No. 10-2002-0063758, filed by Hyundai Motor Company on Oct. 18, 2002, discloses a method for establishing transporting/receiving information between a telematics terminal and a center.

The above-mentioned conventional technology relates to a transporting/receiving data establishing method between the telematics and the center for defining a transporting/receiving wireless data protocol between the telematics terminal and the center which provides information on urgent rescue request, accident notification and traffic information, and diverse convenience information service through information exchange of radio data mounted in the vehicle. The conventional technology provides convenient and reliable information services by defining a standard of information and requesting the information in a Short Message Service (SMS) packet data format and receiving the processed data as SMS packet data.

Since the conventional technology can request the telematics service only in a format of SMS message, there is a problem that the conventional technology cannot provide the telematics service to the telematics terminal having diverse communication schemes.

### SUMMARY OF THE INVENTION

It is, therefore, an object of the present invention to provide a telematics transport gateway for receiving a service request message from a telematics terminal, analyzing a format of messages including Short Message Service (SMS), a packet message such as Transmission Control Protocol (TCP), and a web message such as Hypertext Transfer Protocol (HTTP), processing authentication by extracting user information in the service request message through the process module, charging according to the user information and a kind of services, and transporting the service provided from the service providing server to the telematics terminal, and an operating method thereof.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a telematics transport gateway, including: a message transporting/receiving unit for receiving service request messages of diverse formats from a telematics terminal, transporting the service request messages to a service providing server, receiving a service response message corresponding to the service request message from the service providing server and transmitting the service response message to the telematics terminal; a message processing unit for analyzing whether a format of the service request messages received in the message transporting/receiving unit is Short Message Service (SMS), Transmission Control Protocol (TCP), or Hypertext Transfer Protocol (HTTP); a controlling unit for extracting user information from the service request message analyzed in the message processing unit, transmitting the user information to an authentication managing unit and a charging unit, and maintaining a session with the telematics terminal; the authentication managing unit for performing authentication based on user information from the controlling unit and transporting an authentication result to the controlling unit; and the charging unit for charging for the service based on the user information transmitted from the controlling unit.

In accordance with another aspect of the present invention, there is provided a method for operating a telematics transport gateway, the method including the steps of: a) receiving service request messages of diverse formats from a telematics terminal; b) analyzing whether a format of the transported service request messages is Short Message Service (SMS), Transmission Control Protocol (TCP), or Hypertext Transfer Protocol (HTTP); c) transmitting the service request messages to a service providing server through a corresponding module according to the analyze result; d) performing authentication by extracting user information from the transported service request message; and e) extracting user information from the transported service request message and charging for the service based on the user information.

Also, the present invention can realize a transport part in the form of a module when an application program for the telematics terminal is developed, perform communication in conformity to the transport module on a service providing system and an interface standard and perform communication through a transport gateway of a middle step. Accordingly, the present invention can increase transparency in service development and decrease an entire cost and maintenance cost required for development.

### BRIEF DESCRIPTION OF THE DRAWINGS

The above and other objects and features of the present invention will become apparent from the following description of the preferred embodiments given in conjunction with the accompanying drawings, in which:

FIG. 1 shows a telematics service providing system, to which the present invention is applied;

FIG. 2 is a block diagram showing the telematics transport gateway in accordance with an embodiment of the present invention;

FIG. 3 shows a telematics terminal in accordance with an embodiment of the present invention; and

FIG. 4 shows a telematics service providing server in accordance with the embodiment of the present invention.

### DETAILED DESCRIPTION OF THE INVENTION

Other objects and advantages of the present invention will become apparent from the following description of the embodiments with reference to the accompanying drawings. Therefore, those skilled in the art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

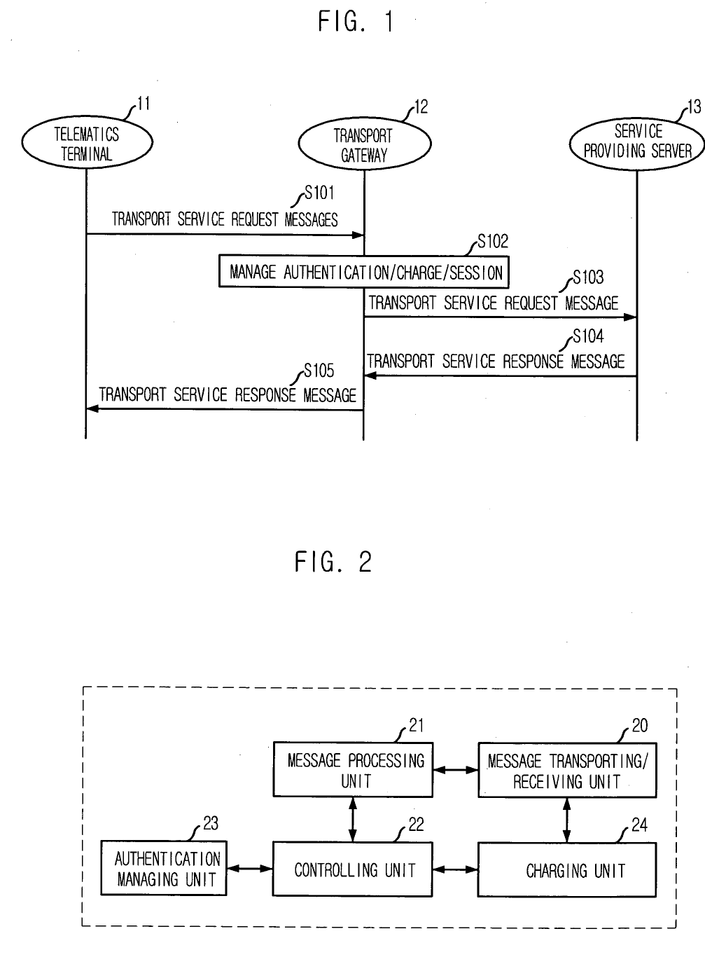

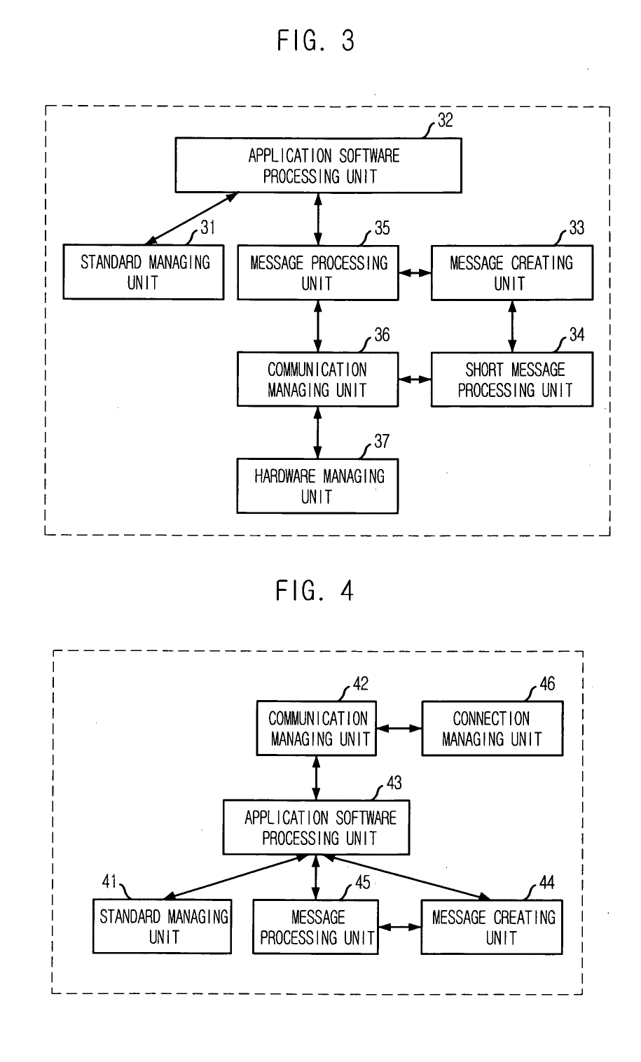

FIG. 1 shows a telematics service providing system, to which the present invention is applied.

The telematics service providing system of the present invention includes a telematics terminal 11, a transport gateway 12 and a service providing server 13.

The telematics terminal 11 creates service request messages of diverse formats upon telematics service request of the user, transports the service request messages to the transport gateway 12 and receives the telematics service according to a response result with respect to the service request message.

The transport gateway 12 receives the service request message from the telematics terminal 11, analyzes Short Message Service (SMS), a packet message such as Transmission Control Protocol (TCP), and a web message such as Hypertext Transfer Protocol (HTTP), processes authentication by extracting user information from the service request message through the process module, charges according to the user information and a kind of services, and transports the service provided from the service providing server 13 to the telematics terminal 11.

The service providing server 13 receives the service request message from the transport gateway 12 and provides the service to the user through the transport gateway 12.

The transport gateway 12 receives the service request message of the short message format through a speech network and the service request message of the packet message or the web message format through a data network.

An operation of the telematics service providing system will be described hereinafter.

At step S101, the telematics terminal 11 receiving a telematics service request from the user transmits service request messages of diverse formats to the transport gateway 12.

At step S102, the transport gateway 12 analyzes a format of the transmitted service request messages including the SMS, the packet message such as TCP, and the web message such as HTTP, processes authentication by extracting user information from the service request messages through the process module, and charges according to the user information and the kind of services.

At step S103, the transport gateway 12 transmits the transmitted service request message to the service providing server 13.

At step S104, the service providing server 13 transmits the service response message corresponding to the transmitted service request message to the transport gateway 13.

At step S105, the transport gateway 12 transmits the service response message transported from the service providing server 13 to the telematics terminal 11.

FIG. 2 is a block diagram showing the telematics transport gateway in accordance with an embodiment of the present invention.

The telematics transport gateway of the present invention includes a message transporting/receiving unit 20, a message processing unit 21, a controlling unit 22, an authentication managing unit 23 and a charging unit 24.

The message transporting/receiving unit 20 receives service request messages of diverse formats from the telematics terminal 11, transmits the service request messages to the service providing server 13, receives a service response message corresponding to the service request message from the service providing server 13 and transports the service response message to the telematics terminal 11.

The message processing unit 21 analyzes the formats of the service request message transported from the message transporting/receiving unit 20 including SMS, the packet message such as TCP, and the web message such as HTTP.

The controlling unit 22 extracts user information from the service request message analyzed in the message processing unit 21, transmits the user information to the authentication managing unit 23 and the charging unit 24 and maintains a session with the telematics terminal 11.

The authentication managing unit 23 performs authentication based on the user information from the controlling unit 22 and transports the authentication result to the controlling unit 22.

The charging unit 24 charges correspondingly to the service based on the user information from the controlling unit 22.

A structure of the telematics terminal will be described hereinafter.

The telematics terminal of the present invention includes a standard managing unit 31, an application software processing unit 32, a message creating unit 33, a short message processing unit 34, a message processing unit 35, a communication managing unit 36, and a hardware managing unit 37.

The standard managing unit 31 manages standard information of a message.

The application software processing unit 32 transports message standard information managed by the standard managing unit 31 upon telematics service request of the user to the message creating unit 33 and controls the message processing unit 35.

The message creating unit 33 creates service request messages of the short message, packet message and web message formats based on the message standard information transmitted from the application software processing unit 32.

The short message processing unit 34 transmits the service request message of the short message formats created in the message creating unit 33.

The message processing unit 35 transmits the packet message created in the message creating unit 33 and the service request message of the web message format.

The communication managing unit 36 controls the hardware managing unit 37 to transmit the service request message of the short message format processed in the short message processing unit 34 and the service request message of the web message format processed in the message processing unit 35 to the transport gateway 12.

The hardware managing unit 37 transmits the service request message of the short message format processed in the short message processing unit 34 and the service request message of the web message format processed in the message processing unit 35 to the transport gateway 12.

A structure of the service providing server of the present invention will be described hereinafter with reference to FIG. 4.

The service providing server of the present invention includes a standard managing unit 41, a communication managing unit 42, an application software processing unit 43, a message creating unit 44, a message processing unit 45, and connection a managing unit 46.

The standard managing unit 41 manages standard information of messages.

The communication managing unit 42 receives a service request message from the transport gateway 12 and transmits a corresponding response message to the transport gateway 12.

The application software processing unit 43 receives the service request message from the communication managing unit 42, transmits the message standard information stored in the standard managing unit 41 to the message creating unit 44 and controls the message processing unit 45.

The message creating unit 44 creates service response messages of the short message, packet message, web message formats based on the message standard information transported from the application software processing unit 43.

The message processing unit 45 transmits the service response message of the packet message and web message format created in the message creating unit 44.

The connection managing unit 46 manages a connection state with the transport gateway 12.

As described above, the present invention provides a new service of a moderate price to a new service developer and a final user by receiving the service request message from the telematics terminal, analyzing the format of messages including SMS, the packet message such as TCP, and the web message such as HTTP, processing authentication by extracting user information from the service request message through the process module, charges according to the user information and the kind of services, and transporting the service provided from the service providing server to the telematics terminal. Also, compatibility between diverse terminals can be realized by extending a unified interface standard.

The present invention can easily develop a service for the telematics terminal without considering detailed articles for transmitting data, and can develop a service server without considering a target terminal or a transport method.

Also, the present invention doubly develops a part related to data transmission maximally applies an advantage data transmission in service development, and of service management by transmitting data and managing services in the transport gateway. Accordingly, the present invention can reduce a cost for developing an entire system by consistently extending the architecture.

As described above, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent applications No. 2005-0091608 and No. 2006-0059464 filed with the Korean Intellectual Property Office on Sep. 29, 2005, and Jun. 29, 2006, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A telematics transport gateway, comprising:
a message transporting/receiving means for receiving service request messages of diverse formats from a telematics terminal, transporting the service request messages to a service providing server, receiving a service response message corresponding to the service request message from the service providing server and transmiting the service response message to the telematics terminal;
a message processing means for analyzing whether a format of the service request messages received in the message transporting/receiving means is Short Message Service (SMS), Transmission Control Protocol (TCP), or Hypertext Transfer Protocol (HTTP);
a controlling means for extracting user information from the service request message analyzed in the message processing means, transmitting the user information to an authentication managing means and a charging means, and maintaining a session with the telematics terminal;
the authentication managing means for performing authentication based on user information from the controlling means and transporting an authentication result to the controlling means; and
the charging means for charging for the service based on the user information transmitted from the controlling means.

2. A method for operating a telematics transport gateway, comprising the steps of:
a) receiving service request messages of diverse formats from a telematics terminal;
b) analyzing whether a format of the transported service request messages is Short Message Service (SMS), Transmission Control Protocol (TCP), or Hypertext Transfer Protocol (HTTP);
c) transmitting the service request messages to a service providing server through a corresponding module according to the analyze result;
d) performing authentication by extracting user information from the transported service request message; and
e) extracting user information from the transported service request message and charging for the service based on the user information.
